(19) United States
(12) Patent Application Publication
(10) Pub. No.: US 2025/0383631 A1
(43) Pub. Date: Dec. 18, 2025

(54) COLOR CLOCK WITH NUMBERS REPRESENTED BY COLORS

(71) Applicant: Aman Bhange, Farmington Hills, MI (US)

(72) Inventor: Aman Bhange, Farmington Hills, MI (US)

(21) Appl. No.: 18/744,692

(22) Filed: Jun. 16, 2024

(51) Int. Cl. G04G 9/04

(52) U.S. Cl. CPC G04G 9/04

(57) ABSTRACT

A clock system that allows a person to view time from a shorter to visible longer distance by identifying colors. To decipher correct time in this clock, a background knowledge of specific color representing specific number is required. In this apparatus, each individual color is represented as a number between number zero to nine and is a set as universal standard for this Colors-numbers system. Traditional digital or analog clock fades when trying to view time as distance increases but now made possible using this color clock. This is a new method to view time and brings a fresh look at seeing time. This Color-number system can be helpful in Physics and various other applications that have time dependent quantities that vary over a distance. However, this literature provides details on this new colors-number clock system and its applications.

### BACKGROUND OF THE INVENTION

Time is an irreversible forward movement, represented using numbers by analog and digital clocks. In physics, operative definition is “Anything that a clock reads”. This disclosure relates generally to a new third way to view time clock other than classic analog and digital methods by representing it via colors such as using single unique color to represent a specific number. This color time clock can be useful for most and be used in electronics devices, smart devices, appliances etc. The color clock method can overcome some of the limitations of viewing analog or digital clocks.

### DESCRIPTION OF THE RELATED ART

The present invention provides a new improved method to display time and can be seen anywhere in between shorter to more long-range distances, subject to no obstruction between the source (clock) and viewer. Traditionally, time is viewed either analytically or digitally so in situations like if the distance between a viewer and clock is far then viewer cannot see time or becomes difficult to interpret a clock time in such situations through these two systems (Viewer and clock). In this invention, the Color time method displays colors rather than the Numbers on a clock. This invention claims to remove most of the limitations on traditional clocks and introduces a new way for most long-range distances. At nighttime, viewing a time can be beautiful and colorful. This system is also useful, to view time without numbers and for people suffering with number reading problems such as dyscalculia issues. This system can also be very useful in space to interpret time even from long distances, as far as the light of the clock can be seen. Moreover, can also be used to convey time by reflection, refraction, diffraction and the possibilities are endless. The most important parameter for this method to be beneficial to most and be useful globally is by making FIG. 1 as universal definition i.e. defining the specific color to its respective number. After setting FIG. 1. As a universal standard, the applications are far beyond a clock and can be used in any situations where any kind of numbers are displayed.

Color clock can be useful at various locations such as tall towers, buildings, parks, restaurants, Historic monuments lighthouses, Motor vehicles, ships, rockets, planes and outer space where, if the traditional time systems become invisible, when viewed from an angle or from longer distance. This has resulted in a desire to develop a new method, system to interpret time and a device that displays time in a more effective way. Viewing time is now possible for longer distances and can be highly beneficial in space and underwater as compared to traditional clocks. Most importantly, the clock that represents time by colors is referred to as “Color clock” and the time displayed on this clock is referred as “Color time.” The universal standard as per FIG. 1. Is referred to as “Color-number system” and abbreviated as “Column”.

### SUMMARY OF THE INVENTION

The present disclosure provides a display output, system, method, and apparatus for representation of time in a 12-hour clock and 24-hour clock. In general, the color entity can be colored-lights, bands, rings, laser lights or any light emitting source and the display to represent colors can be any geometrical definite shape, indefinite shape, two-dimensional and three-dimensional objects. This clock is useful in various applications both in software and hardware devices. Here, Microsoft office-excel program software is being used to represent time in software platform and a Microcontroller Electronic Circuit device is used to represent time as a hardware platform. Although both platforms need programming and certain apparatus, the output result of representing time in both platforms are similar. In excel, mathematical formulae and macros solver are used to convert digital time to a color time format display. In electronic circuits, microcontrollers with LED's is used for the circuit.

### BRIEF DESCRIPTION OF THE DRAWING

The patent drawing file contains five figures and is submitted with this application. In the following, the present application will be explained in detailed with reference to the example embodiments shown in the drawings, in which:

FIG. 1 is a table showing Colors-numbers Table (Print in black and white format of colors).

FIG. 2 is a flow chart of MS-excel spreadsheet to create color time for software apps.

FIG. 3 is the time shown in the traditional digital way (11 am, 02 mins and 37 seconds).

FIG. 4 is example Color time display representing numbers same as FIG. 3 the time output ((Print in black and white format of colors) C₁ is Black representing 1, C₂ is Black representing 1, C₃ is White representing 0, C₄ is purple representing 2, C₅ is Red representing 3 and C₆ is Hot Pink representing “7”)

FIG. 5 is an example time of Traditional Digital clock equivalent to FIG. 4

### DETAILED DESCRIPTION

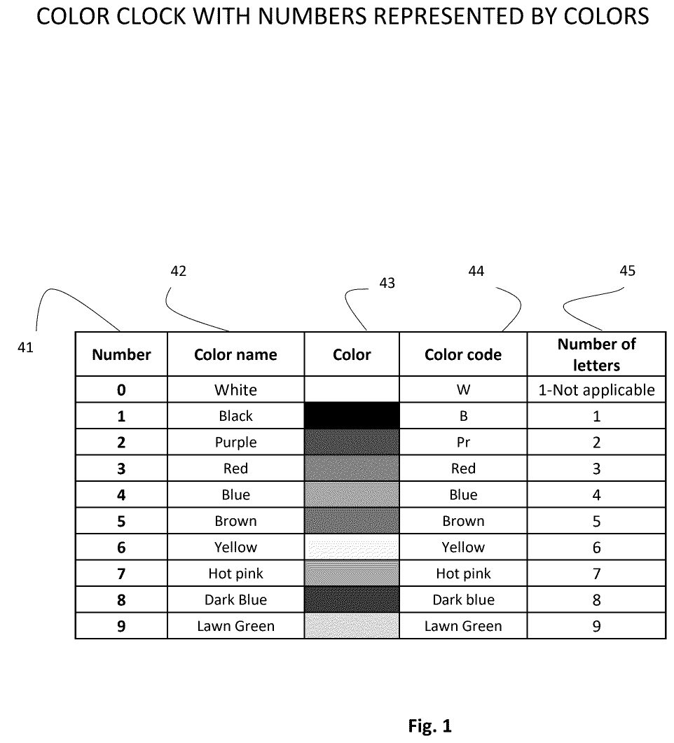

In FIG. 1, ten colors are represented as respective numbers. Columns-First Row of Column's are as follows: Column 41 contains Numbers from 0 to 9. Column 42 has the corresponding names of the colors for numbers in column 41 respectively. The black and white shades in Column 43 are the actual color as shown in Column 42's Color names respectively. Column 44 is color code for column 43 and Column 45 respectively. Column 45 is the number of letters in Column 44 “Color code” to represent column 43. The goal here is to show the relation between colors and numbers and that a color will be displayed as a number. So, Column 43 color will be displayed corresponding to its designated number in Column 45 respectively. Second Row—As White is common color and color code “W” is representing number “zero” or “0” then color White would be known as number “zero” or “0”. As number of letters in color code “B” is one, Color Black is representing number “1” so, color Black would be known as number “1”. Similarly, as number of letters in color code “Pr” is two thus purple is representing number “2” so, color Purple would be known as number “2”. As number of letters in color code “Red” is three thus red represents number “3” so, color Red would be known as number “3”. As the number of letters in color code “Blue” is four thus blue represents the number “4” so, color Blue would be known as number “4”. As number of letters in color code “Brown” is five thus brown represents the number “5” so, color Brown would be known as number “5”. As number of letters in color code “Yellow” is six thus yellow is representing number “6” so, color yellow would be known as number “6”. As number of letters in color code “Hot pink” is seven thus hot pink represents number “7” so, color hot pink would be known as number “7”. As number of letters in color code “Dark blue” is eight thus dark blue represents the number “8” so, color Dark blue would be known as number “8”. As number of letters in color code “Lawn green” is nine thus lawn green represents the number “9” so, color lawn green would be known as number “9”. In summary colors, white means Zero, black means one, purple means two, red means three, blue means four, brown means five, yellow means six, hot pink means seven, dark blue means eight and lawn green means 9, As here each unique color represents a unique number.

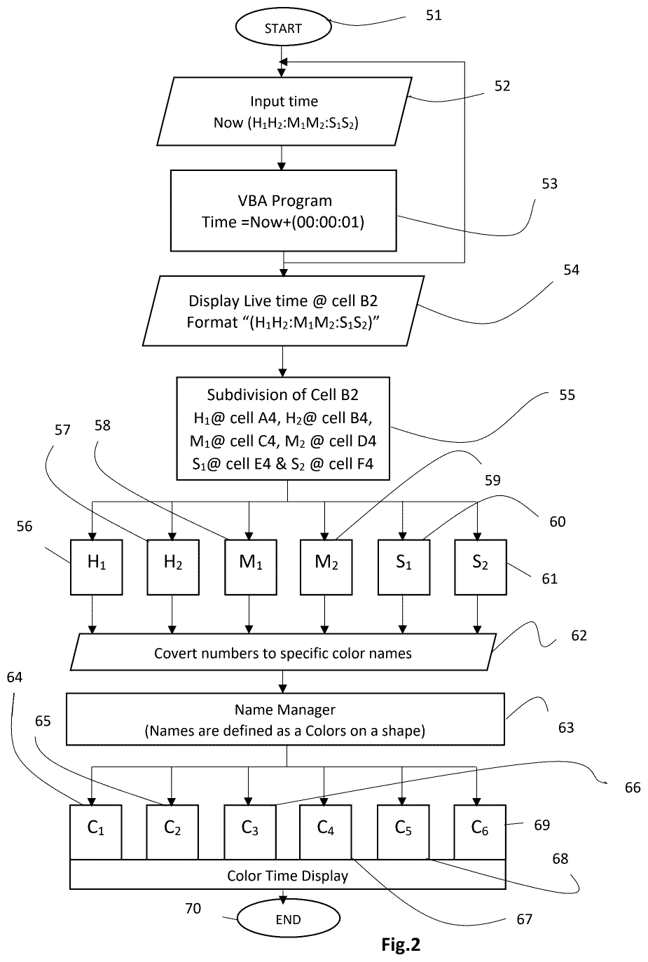

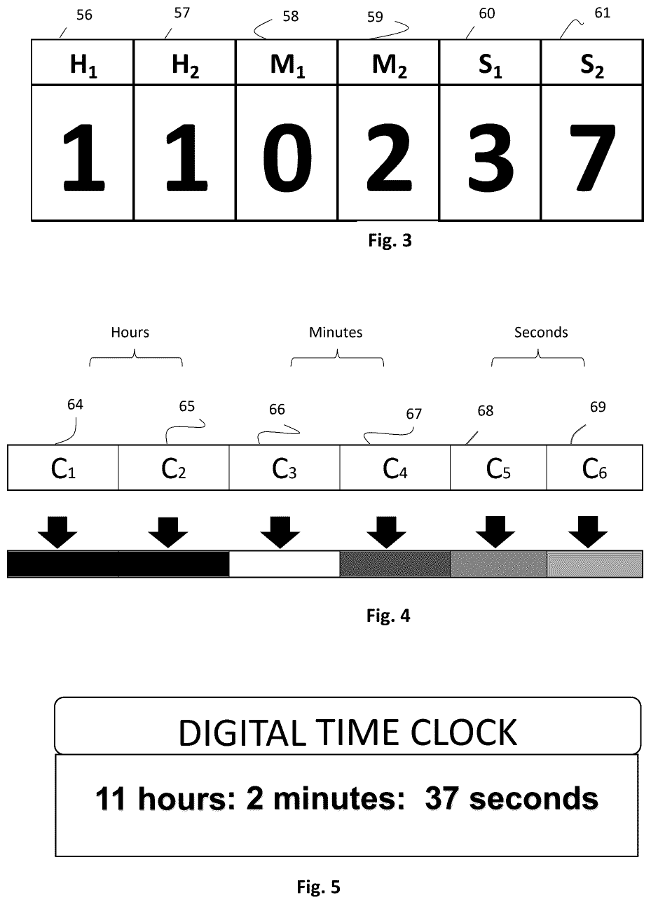

FIG. 2: For Software applications, for example color time display, the steps in FIG. 2 are used to create a color time in a spreadsheet. The time output can be easily converted for any device's operating system platforms and is useful for any devices which have time display or runs on time. In FIG. 2, 51 is cell B2 where the program starts. B is the column number and 2 is the row number. With Now ( ) function present time is 52 inputs in the cell. Using a specific 53 VBA program in developer command, the present time is refreshed every single second, and a single second is added to it at the same time. Thus, it's converted into live time 54. The live time is then distributed into six different cells using time functions such as Hour ( ) Minutes ( ) and Seconds ( ) and basic mathematical formulas such as division, subtraction, Mod etc. 56, 57 and 64, 65 are the hour display; 58, 59 and 66, 67 are the minutes display and 60, 61 and 68, 69 are the seconds display for digital time and color time respectively. After separation, each color is defined as a specific name in the 63 Name manager. The specific names are defined as specific numbers 62 using conditional statements such as “If Else” statements. Further, Shapes are selected to display color time, program starts running, and the color time is displayed. The time loop is continuous until its 70 stopped. The output will be a Color time display as shown in FIG. 4.

In FIG. 4: For Hardware applications Color time display model, any Light emitting source or objects such as colored light bulbs, LEDs can be used for Clock output. LED stands for Light emitting diode. Here, PIC microcontroller LED electronic circuit is used for color clock device, Color lights are used as display colors. The logic and LED time change for time display are as follows: Hour has 2 display A₁ and A₂ similar to 64 and 65. For a 12-hour clock, A₁ will have 2 light sources and for a 24-hour clock A₁ will have 3 light sources. There are six series of light sources C₁, C₂, C₃, C₄, C₅, C₆. C₁ and C₂ are for hours, C₃ and C₄ are for minutes and C₅ and C₆ are for seconds. In FIG. 4 the hour display has 2 light sources i.e., White and Black and similar for minutes: seconds. But each light source individually has ten lights for unit place digit of seconds, minutes or hour and has 6 lights for ten's place digit for minutes and seconds. For a 12-hour format and 24-hour format the hour's tenth place digit has two lights and 3 lights sources respectively, Overall, only one light from each source glows i.e. is on. Example C₁ has 10 light sources i.e., White, Black, purple, red, blue, brown, yellow, hot pink, dark blue and lawn green. Similarly, C₃ and C₄ are 66, 67 has 6 light sources i.e., White, Black, purple, red, blue, brown and 10 light sources i.e., White, Black, purple, red, blue, brown, yellow, hot pink, dark blue and lawn green respectively. Similarly, C₁ and C₂ are 68, 69 and have 6 light sources i.e., White, Black, purple, red, blue, brown and 10 light sources i.e., White, Black, purple, red, blue, brown, yellow, hot pink, dark blue and lawn green respectively. Each series of light sources will be programed, and clock time logic will be generated. Most importantly, Colors are changed at their time interval or until a programmed cycle is completed both in software and hardware application. 69 changes color every 1 second, 68 changes color every 10 seconds. 67 changes color every 1 minute, 66 changes color every 10-minute, 65 changes color every 1 hour and 64 changes color every 10 hour.

As per the teachings of this present application a prototype Color Clock device, in which Numbers are represented by Colors to display color time (11 am, 2 minutes and 37 seconds) as shown in color bar of FIG. 4 consist of the following for demonstration purpose of this application. The output of this device is as shown in FIG. 4 of this device is six colored lights representing Color time and it consist of:
a) Programmed PCB with multiple-colored lights displaying color time
b) A switch to turn off and on the clock device
c) Push buttons to set and adjust time
d) Battery holder or port for electric power source.
e) A battery for power supply or a wired plug for electric adapter connection
f) A Frame for placing all the electronics components inside it
g) A Material Layer on top of color lights to emit colors outside efficiently
h) Color clocks have 6 outputs as “HH: MM: SS” where HH stands for hours, MM stands for minutes and SS for seconds. Either 6 display outputs (To show hours, minutes and seconds) or 4 display outputs (To show hours and minutes) can be used to display Color time.

Although, the present application has been described in detail for illustration purposes. The teachings of the present methodology of displaying color time and color clock may also be applied to other types of electronic devices, such as wall clocks, smart watches mobile phones, computers, company branding logo's etc. it may also be noted that there are many alternate ways of implementing the methods and apparatuses of the teachings of the present application. The features of this application of this invention is believed to be important, it should be interpreted that the claims and drawings are new solutions to existing clocks system and have multiple advantages if used at right locations.

### REFERENCES

Time-Wikipedia links: https://en.wikipedia.org/wiki/Time https://en.wikipedia.org/wiki/Clock and https://en.wikipedia.org/wiki/Digital_clock

1. A method for identifying a number by its color.

2. A method as claimed in claim 1 wherein a color is identified by a single digit number.

3. A method as claimed in claim 2 wherein all types of light emitting source being used to interpret numbers by displaying colors.

4. A method as claimed in claim 3 wherein Numbers that are as follows-zero (0), One (1), Two (2), Three (3), Four (4), Five (5), Six (6), Seven (7), Eight (8) and Nine (9) are equivalent to white, black, purple, red, blue, brown, yellow, hot pink, dark blue and lawn green respectively.

5. A method as claimed in claim 4 wherein a light source can be one of the combinations from ten color lights (white, black, purple, red, blue, brown, yellow, hot pink, dark blue and lawn green), six color lights (white, black, purple, red, blue, brown), three color lights (White, Black, purple) or two color lights white, black).

6. A method as claimed in claim 5 wherein colored lights are used to display time in formats of Hours: Minutes: Seconds and Hours: Minutes.

7. A method as claimed in claim 6 wherein Hours, Minutes and Seconds are each separate light sources with multiple color lights represented as H, M and S respectively.

8. A method as claimed in claim 7 wherein only one light out of the multiple lights is on in Hour's light source, one light out of the multiple lights is on in Minutes light source and one light out of the multiple lights is on in seconds light source.

9. A method as claimed in claim 8 wherein formats for displaying time can be HH:MM: SS, HH:MM, SS:MM: HH, MM: SS: HH, MM:HH, SS:HH:MM, SS, MM and HH where HH is Hours, MM is Minutes and SS is seconds of a typical digital time display.

10. A method as claimed in claim 8 wherein changing light from one color to another color are as per color change per second (CC/sec) for each light source:

11. A method as claimed in claim 9 wherein the Hours display has two light sources. The tenth decimal place hour digit number will CC per every hour or CC per 10 hours for 12 hour and 24 hours format respectively.

12. A method as claimed in claim 9 wherein the Minutes display has two light sources. First source—The tenth decimal place Minute digit color will color change per ten minutes. Second source—Minutes unit digit display will color change per one minute

13. A method as claimed in claim 9 wherein the Seconds display has two light sources. First source-The tenth decimal place of Seconds digit color will color change per ten seconds. Second source-Unit decimal place digit display will color change per one second.

14. A method as claimed in claims 11, 12 and 13 and changing light colors at a frequency of one second, ten seconds, one minute, ten minutes, one hours and ten hours.

15. A method as claimed in claim 14 wherein the rate of changing colors in a light source system with either 4 different light colors or six different light colors.

16. A method as claimed in claim 15 wherein the HH, MM and SS light source is separated by one of the special symbols such as (:,-;*_/|.& #)

17. A method as claimed in claim 16 wherein A color displayed for a number is called “Cigit” and expressed as Color Digit.

18. A method as claimed in claim 17 wherein establishing a universal color numbering system displayed by colors for their corresponding numbers.
